(19) United States
(12) Patent Application Publication
(10) Pub. No.: US 2010/0149457 A1
(43) Pub. Date: Jun. 17, 2010

(54) LIQUID CRYSTAL DISPLAY MODULE, LIQUID CRYSTAL DISPLAY AND ITS ILLUMINATOR

(75) Inventor: Hiroshi Yamaguchi, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Kadoma-shi, Osaka (JP)

(21) Appl. No.: 12/297,144

(22) PCT Filed: Apr. 17, 2007
(86) PCT No.: PCT/JP2007/058363

§ 371 Date: Oct. 14, 2008

(30) Foreign Application Priority Data
Apr. 17, 2006 (JP) 2006-113147

(51) Int. Cl. G02F 1/13357; G02F 1/1335; G09F 13/04

(52) U.S. Cl. 349/64; 349/68; 362/97.2

(57) ABSTRACT

A liquid crystal display module in which its color shift is reduced. The liquid crystal display module comprises a liquid crystal panel having such wavelength dependency that the transmittance to incident illumination light is different depending on both the incident angle and the wavelength of the illumination light and its anisotropy is different in the lateral direction and the vertical direction, and a plurality of single color light sources having different light distribution characteristics of emission wavelength and illuminating the liquid crystal panel from the back, wherein the plurality of single color light sources emit illumination light having light distribution characteristics for relaxing the wavelength dependency and the anisotropy.

### TECHNICAL FIELD

The present invention relates to a liquid crystal display module, liquid crystal display apparatus, and illumination apparatus thereof.

### BACKGROUND ART

Thin, lightweight liquid crystal display apparatuses capable of image display have rapidly become widespread due to price reductions and the development of high-image-quality technology resulting from advances in manufacturing techniques, and are widely used in personal computer monitors, TV receivers, and the like.

A transmission liquid crystal display apparatus is generally used as a liquid crystal display apparatus. A transmission liquid crystal display apparatus is equipped with a planar light source called a backlight, illumination light from which is spatially modulated by a liquid crystal panel and forms an image.

One problem in terms of the performance of such a liquid crystal display apparatus is the “color shift” phenomenon whereby colors vary according to the observation direction. This is due to the fact that there is angular dependency in the transmittance of emitted light of a liquid crystal panel, and there is also anisotropy in wavelength dependency (wavelength dispersion). Another problem is anisotropy in a light distribution characteristic of a backlight.

FIG. 1 is a graph showing the results of measuring a horizontal (liquid crystal panel horizontal-direction) light distribution characteristic when the single colors red, blue, and green are displayed by a liquid crystal display apparatus that uses TN liquid crystal. It can be seen that long-wavelength red light shows a relatively wide light distribution profile, while short-wavelength blue light shows a relatively narrow light distribution profile.

FIG. 2 is a graph showing the results of evaluating a light distribution characteristic via red, green, and blue color filters when the liquid crystal panel of the liquid crystal display apparatus used for the FIG. 1 measurements is removed and the backlight is lit. As can be seen from FIG. 2, no particular wavelength dispersion is perceived in illumination light from the backlight, and it is evident that the pronounced wavelength dispersion perceived in FIG. 1 is due to the characteristics of the liquid crystal panel.

As a result of the above light distribution characteristic, when a screen displaying white is observed, it appears bluish from a relatively frontal direction and reddish from a direction at a large angle. This is illustrated schematically in FIG. 3.

In order to lessen the above color shift phenomenon, a method has been proposed whereby light sources of each of the three primary colors are used, and these are made incident on a light-guide-plate-side surface with a different light distribution characteristic (see Patent Document 1).
Patent Document 1: Japanese Patent Application Laid-Open No. 2004-61693

### DISCLOSURE OF INVENTION

### Problems to be Solved by the Invention

However, a problem with the method of using light sources of each of the three primary colors, and making these incident on a light-guide-plate-side surface with a different light distribution characteristic, is a tendency for color unevenness to occur.

A light guide plate repeatedly performs full reflection between opposing main surfaces of light incident from an end surface, propagating the light toward the end surface opposite the incident end, and emits part of that light by means of a diffusion section provided on one opposing main surface or a diffusion material dispersed within the light guide plate.

In order to obtain uniform illumination from the entire surface of the light guide plate, it is necessary to set the formation density and pattern size distribution of the diffusion section, and the diffusion density distribution of the diffusion material, appropriately. However, the incident light propagation and emission situation varies according to the light distribution pattern of the incident light. Specifically, when light distribution of incident light is wide, the proportion of light emitted from the vicinity of the incident surface of the light guide plate is large, the incident side of the light guide plate is bright, and the opposite side is dark. Conversely, when the directivity of incident light is sharp, the incident side of the light guide plate is dark, and the opposite side is bright.

For example, when the light distribution pattern of blue light is widened relatively and is incident on the light guide plate, as in the implementation example of Patent Document 1, color unevenness occurs, with the vicinity of the incident side of the light guide plate becoming bluish, and the opposite side reddish.

Therefore, a difficulty with the method whereby the light distribution pattern is varied lies in reconciling lessening of the observation angle related color shift phenomenon with achievement of a uniform display showing no color unevenness over the entire screen.

Also, depending on the liquid crystal panel mode, the above-described color shift phenomenon does not necessarily occur equally and isotropically in the vertical, horizontal, and diagonal directions.

FIG. 4 shows the results of measuring a vertical (liquid crystal panel vertical-direction) single-color light distribution characteristic when the same kind of single-color display is performed using TN liquid crystal for which the characteristic in FIG. 1 was measured. As can be seen from FIG. 4, for the vertical direction, there is no significant wavelength dispersion within a range of [practical viewing angle range±40°]. Therefore, when wavelength dispersive illumination is also performed in the vertical direction in the same way as in the horizontal direction, a color shift is actually generated. Also, compared with the horizontal-direction light distribution characteristic shown in FIG. 1, the vertical-direction light distribution characteristic shows a marked drop in transmittance as the measurement angle increases. That is to say, there is anisotropy in the light distribution characteristic in emitted light from the liquid crystal display apparatus. This light distribution characteristic anisotropy is a characteristic of the backlight.

Therefore, in order to reduce a color shift in the vertical, horizontal, and diagonal directions, it is necessary to emit illumination light that imparts wavelength dependency in the horizontal direction, and give anisotropy to the wavelength dependency of illumination light. However, a problem with the conventional method of using a light guide plate and varying the directivity of light incident from a side surface thereof is that it is difficult to control wavelength dependency and anisotropy of wavelength dependency.

The present invention has been implemented taking into account the problems described above, and it is an object of the present invention to provide a liquid crystal display module, liquid crystal display apparatus, and illumination apparatus thereof that lessen a color shift for various observation angles—horizontal, vertical, and diagonal—even when using a liquid crystal panel having wavelength dependency whereby transmittance for incident illumination light differs according to both the incident angle and wavelength of illumination light, and also having anisotropy whereby the wavelength dependency differs in the horizontal direction and the vertical direction.

### Means for Solving the Problems

A liquid crystal display module of the present invention is equipped with a liquid crystal panel having wavelength dependency whereby transmittance for incident illumination light differs according to both the incident angle and wavelength of illumination light, and also having anisotropy whereby wavelength dependency differs in the horizontal direction and the vertical direction, and a plurality of single-color light sources whose emission wavelength light distribution characteristics differ and that illuminate the liquid crystal panel from the back surface; wherein the plurality of single-color light sources emit illumination light having a light distribution characteristic that lessens wavelength dependency and anisotropy.

An illumination apparatus of the present invention illuminates from its back surface a liquid crystal panel having wavelength dependency whereby transmittance for incident illumination light differs according to both the incident angle and wavelength of illumination light, and also having anisotropy whereby wavelength dependency differs in the horizontal direction and the vertical direction; and employs a configuration equipped with a plurality of single-color light sources whose emission wavelength light distribution characteristics differ, and a base on which the plurality of single-color light sources are arranged; wherein the plurality of single-color light sources emit illumination light having a light distribution characteristic that lessens wavelength dependency and anisotropy.

A liquid crystal display apparatus of the present invention employs a configuration equipped with a liquid crystal panel having wavelength dependency whereby transmittance for incident illumination light differs according to both the incident angle and wavelength of illumination light, and also having anisotropy whereby wavelength dependency differs in the horizontal direction and the vertical direction, an illumination section that has a plurality of single-color light sources whose emission wavelength light distribution characteristics differ and that illuminate the liquid crystal panel from the back surface, and illuminates the liquid crystal panel from the back surface, and a display control circuit that drives the liquid crystal panel and displays an image; wherein the plurality of single-color light sources emit illumination light having a light distribution characteristic that lessens wavelength dependency and anisotropy.

### Advantageous Effect of the Invention

A liquid crystal display apparatus of the present invention makes possible image display in which the occurrence of color unevenness is reduced.

### BRIEF DESCRIPTION OF DRAWINGS

FIG. 1 is a graph showing a horizontal light distribution characteristic when single-color display is performed by a TN liquid crystal display apparatus;

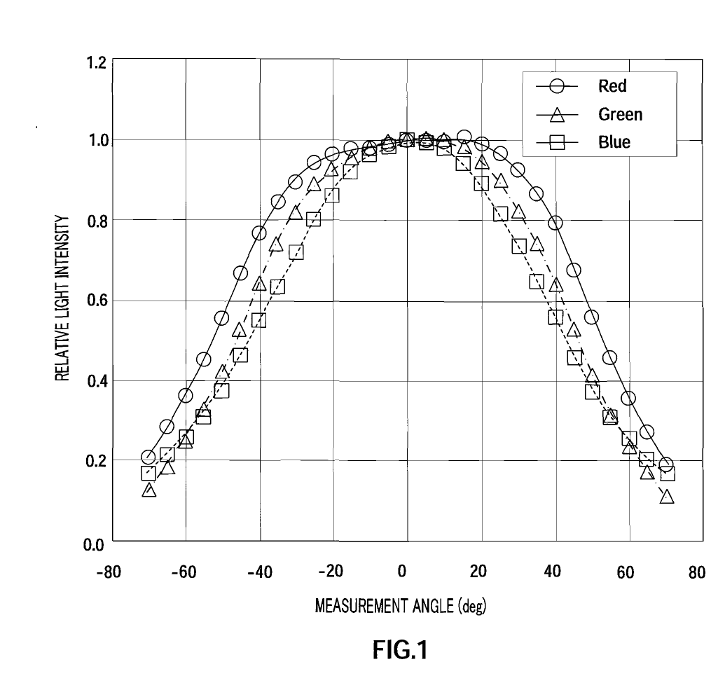

FIG. 2 is a graph showing the results of evaluating a light distribution characteristic via red, blue, and green color filters when the liquid crystal panel of the liquid crystal display apparatus used for the FIG. 1 measurements is removed and the backlight is lit;

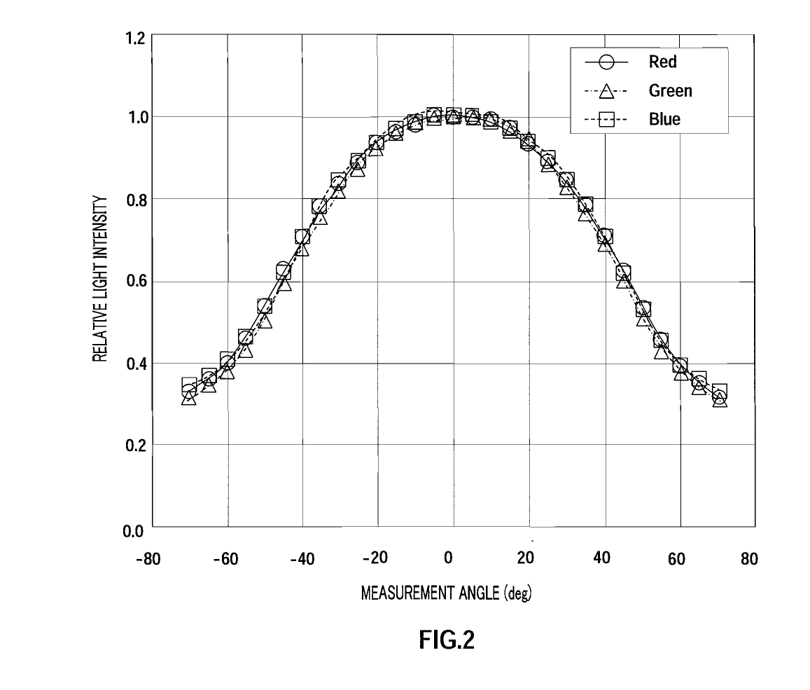

FIG. 3 is a schematic diagram showing the state of color shift occurrence when a liquid crystal panel is illuminated by general illumination with no wavelength dispersion;

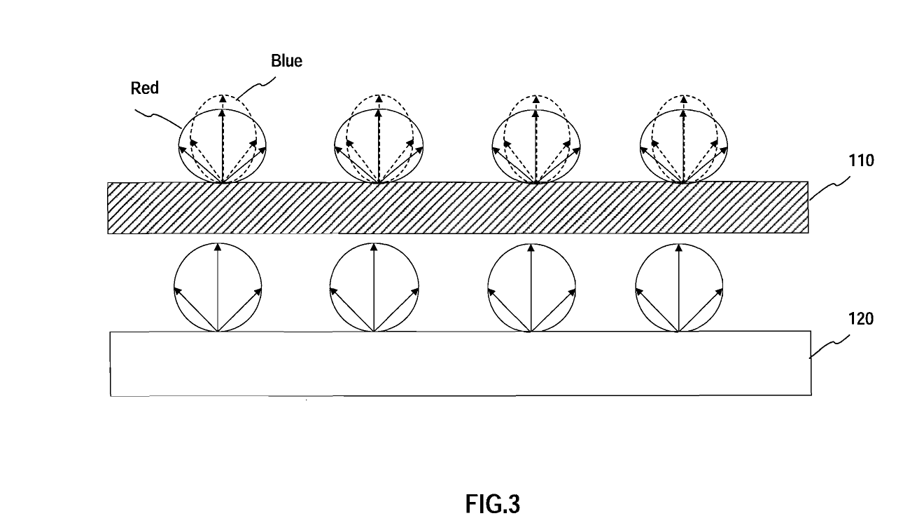

FIG. 4 is a graph showing a vertical light distribution characteristic when single-color display is performed by a TN liquid crystal display apparatus;

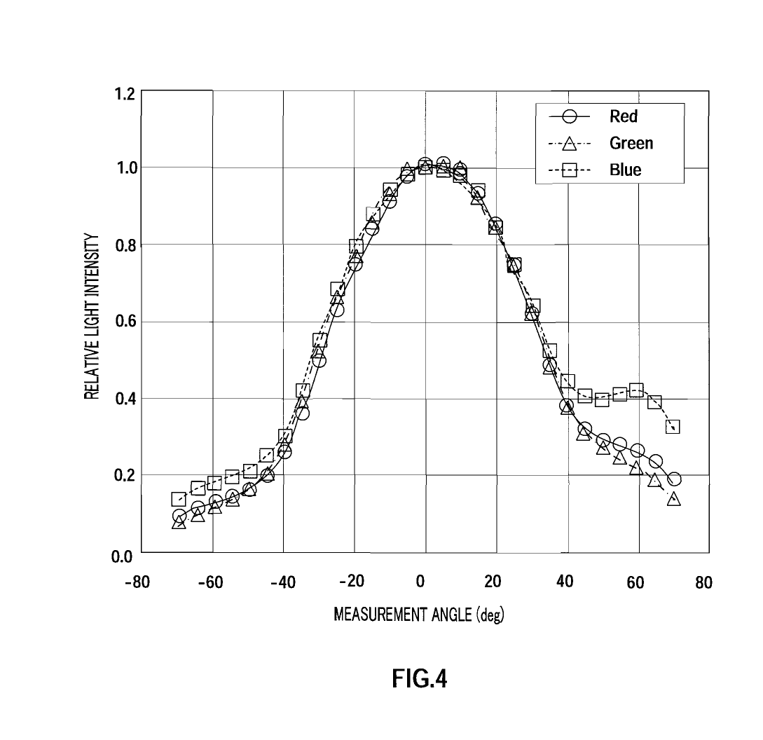

FIG. 5 is a perspective view showing the configuration of an embodiment of a liquid crystal display module of the present invention;

FIG. 6 is a perspective view showing the configuration of an anisotropic wavelength dispersive light source unit according to an embodiment of a liquid crystal display module of the present invention;

FIG. 7 is a cross-sectional diagram explaining the operation of an embodiment of a liquid crystal display module of the present invention;

FIG. 8A is a graph showing the wavelength dependency of the refractive index of PMMA and MS, and FIG. 8B is a graph showing the wavelength dependency of the relative refractive power (∝ refractive index difference) with PMMA, MS, and air media-combinations; and

FIG. 9 is a drawing showing an example of a matrix-type liquid crystal display apparatus.

### BEST MODE FOR CARRYING OUT THE INVENTION

The Embodiment of the present invention will now be described with reference to the accompanying drawings.

### Embodiment 1

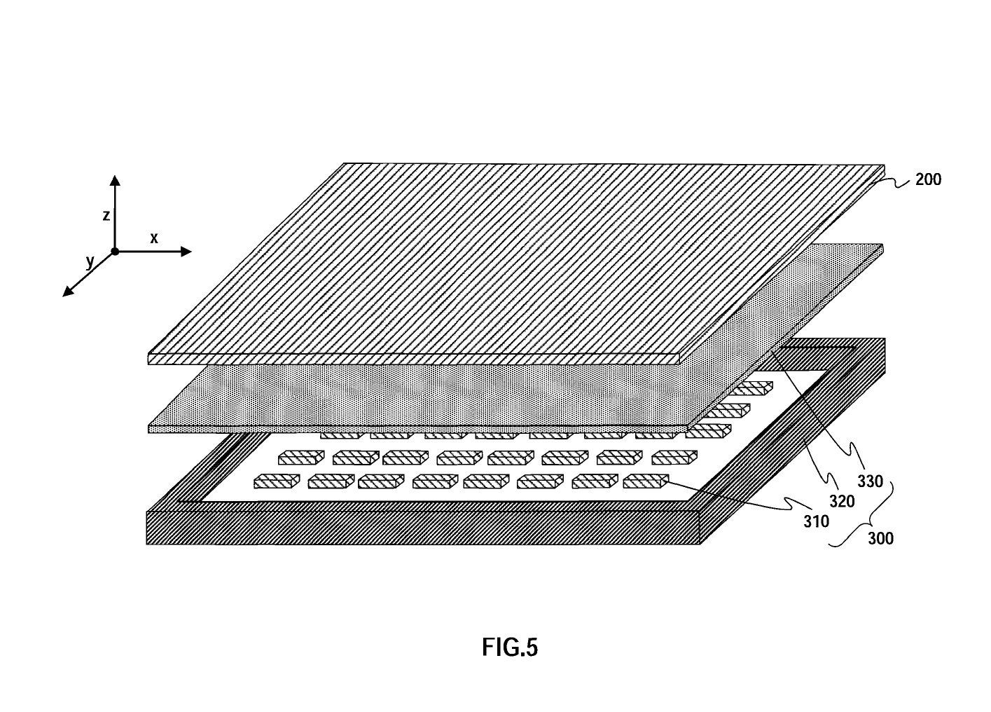

FIG. 5 is a perspective view showing the configuration of an embodiment of a liquid crystal display module of the present invention.

As an illumination apparatus of a liquid crystal display module, wavelength dispersive planar light source 300 (corresponding to an “illumination apparatus” of the present invention) is configured with many wavelength dispersive light source units 310 arranged inside frame 320 serving as a base, covered by diffusion sheet 330. The layered coding apparatus illumination apparatus is positioned below liquid crystal panel 200.

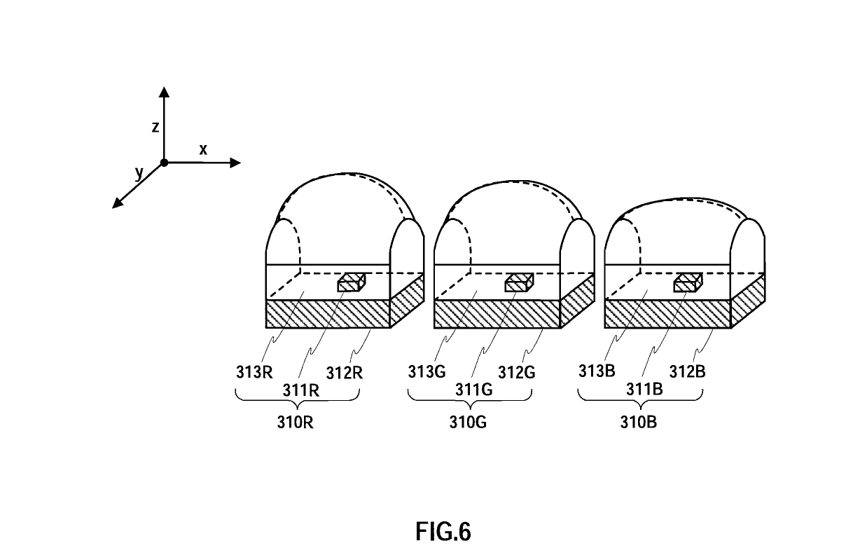

FIG. 6 is a perspective view showing the configuration of wavelength dispersive light source unit 310 in a liquid crystal display module of Embodiment 1. Red LED chip 311R is mounted on substrate 312R. Red LED chip 311R is sealed with transparent resin 313R, forming red light source element 310R. Green light source element 310G and blue light source element 310B are formed in a similar way using green LED chip 311G and blue LED chip 311B. Wavelength dispersive light source unit 310 is configured by means of above red light source element 310R, green light source element 310G, and blue light source element 310B.

Red light source element 310R, green light source element 310G, and blue light source element 310B have different shapes for the projecting part of the sealing resin to cause the emission wavelength light distribution characteristics to differ. Setting is performed so that, in the x direction in FIG. 6, light distribution of blue light source element 310B is relatively wide, light distribution of red light source element 310R is relatively narrow, and light distribution of green light source element 310G is intermediate. That is to say, the shapes of the projecting parts of the sealing resin are formed so that light diffusion of blue light source element 310B is relatively large. Thus, setting is performed so that light emitted from the plurality of single-color light sources has wavelength dependency that is the reverse of the wavelength dependency of the liquid crystal panel. The light distribution characteristics of the plurality of single-color light sources are thus set so that light emitted from the plurality of single-color light sources lessens the wavelength dependency of liquid crystal panel 200. Settings are also made so that the light distribution characteristic is the same for 310R, 310G, and 310B in the y direction in FIG. 6. As stated above, there is no significant wavelength dependency in the y direction. Therefore, setting an identical light distribution characteristic for 310R, 310G, and 310B in the y direction enables wavelength dependency anisotropy to be lessened. Thus, there is wavelength dispersion in the x direction and no wavelength dependency in the y direction, and wavelength dispersive light source units 310 having wavelength dependency and anisotropy in wavelength dependency can be obtained.

The plurality of light sources (310R, 310G, and 310B) may also have light distribution characteristics such that a light distribution characteristic of emitted light differs in the liquid crystal panel 200 horizontal direction (x direction) and vertical direction (y direction). Specifically, horizontal-direction light distribution is wider than vertical-direction light distribution. For example, the plurality of single-color light sources are arranged so as to have directivity in the liquid crystal panel 200 horizontal direction, and are arranged so as to have alight distribution characteristic with large diffusion in the liquid crystal panel 200 vertical direction. Making diffusion large in the liquid crystal panel 200 vertical direction enables a diffusion sheet with relatively high diffusion in the horizontal direction to be used. By this means, the plurality of single-color light sources are configured so as to adjust the light distribution characteristic balance in the vertical direction and in the horizontal direction. Moreover, taking a characteristic of the diffusion sheet into consideration, it is possible to make a setting so that the characteristics of the plurality of single-color light sources lessen liquid crystal panel wavelength dependency and anisotropy, and adjust the light distribution characteristic balance.

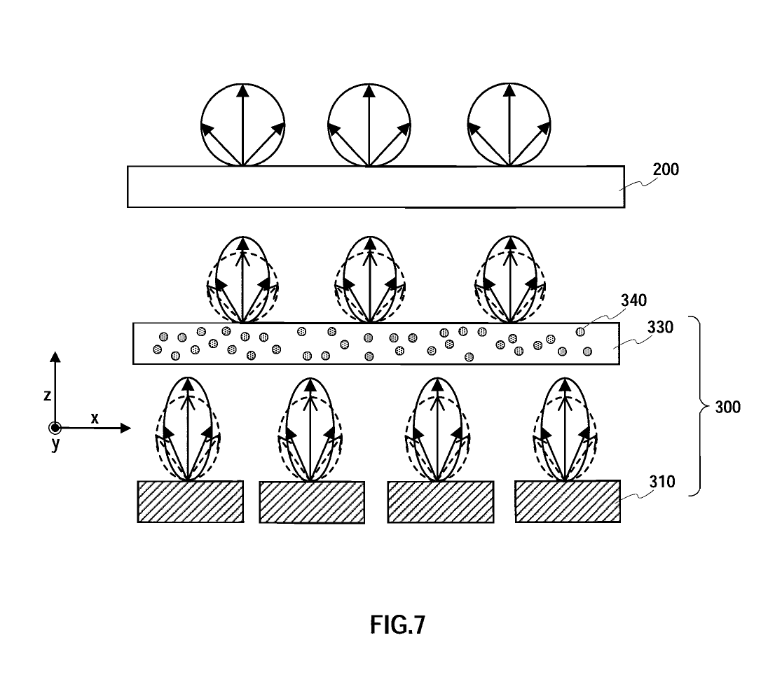

Operation details will now be explained using FIG. 7.

FIG. 7 is a cross-sectional diagram of an embodiment of a liquid crystal display apparatus of the present invention, showing the principal parts in FIG. 5 sectioned through the xz plane.

As described above, wavelength dispersive light source unit 310 emits light with comparatively sharp directivity for long-wavelength red light (solid lines in FIG. 7), and emits light with comparatively large diffusion for short-wavelength blue light (dotted lines in FIG. 7).

Diffusion sheet 330 has an effect of increasing the uniformity of illumination by re-diffusing light from wavelength dispersive light source unit 310. Light transmitted through diffusion sheet 330 has its diffusion somewhat increased and its wavelength dispersion somewhat lessened. The light distribution characteristics of the plurality of single-color light sources and the light distribution characteristic of the diffusion sheet are set so as to correct wavelength dependency and anisotropy of wavelength dependency of emitted light from the liquid crystal panel. The light distribution characteristic of diffusion sheet 330 is set so as to complement the light distribution characteristics of the plurality of single-color light sources. Also, the light distribution characteristics of the plurality of single-color light sources may be set so as to complement the light distribution characteristic of diffusion sheet 330.

The light distribution characteristics of wavelength dispersive light source units 310 and the diffusion characteristic of diffusion sheet 330 are set so that wavelength dispersion of a light distribution characteristic of light transmitted through diffusion sheet 330 lessens the wavelength dispersion of transmittance of liquid crystal panel 200.

As a result, light that has been transmitted through the liquid crystal panel has fixed proportions of red, blue, and green regardless of the observation angle, and color shift occurrence can be reduced within an effective viewing range.

In the y direction, anisotropic wavelength dispersive light source unit 310 emits light with equal light distribution profiles for red, blue, and green. The emitted light then passes through diffusion sheet 330 and is incident on liquid crystal panel 200 with equal light distribution profiles. Since there is no significant wavelength dispersion within the effective viewing range of liquid crystal panel 200 in the y direction, no new color shift occurs.

In the above embodiment, a TN liquid crystal substrate is used that has anisotropy in wavelength dispersion of incident angle dependency of transmittance, and anisotropic wavelength dispersive illumination (by anisotropic wavelength dispersive light source units 310) is used that has wavelength dispersion and anisotropy in wavelength dependency. However, the present invention is not limited to this. For example, if liquid crystal whose transmittance wavelength dispersion is virtually isotropic, such as VA liquid crystal, is used, it is desirable to use illumination for which the wavelength dispersion of illumination light is also isotropic.

Diffusion sheet 330 may be configured in such a way that light diffusers having a refractive index different from the refractive index of a transparent base material are dispersed in the thickness direction of the transparent base material, incident light from the plurality of single-color light sources is refracted a plurality of times, wavelength dependency that is the reverse of the wavelength dependency can be imparted to light emitted from the plurality of single-color light sources, and that light can be emitted.

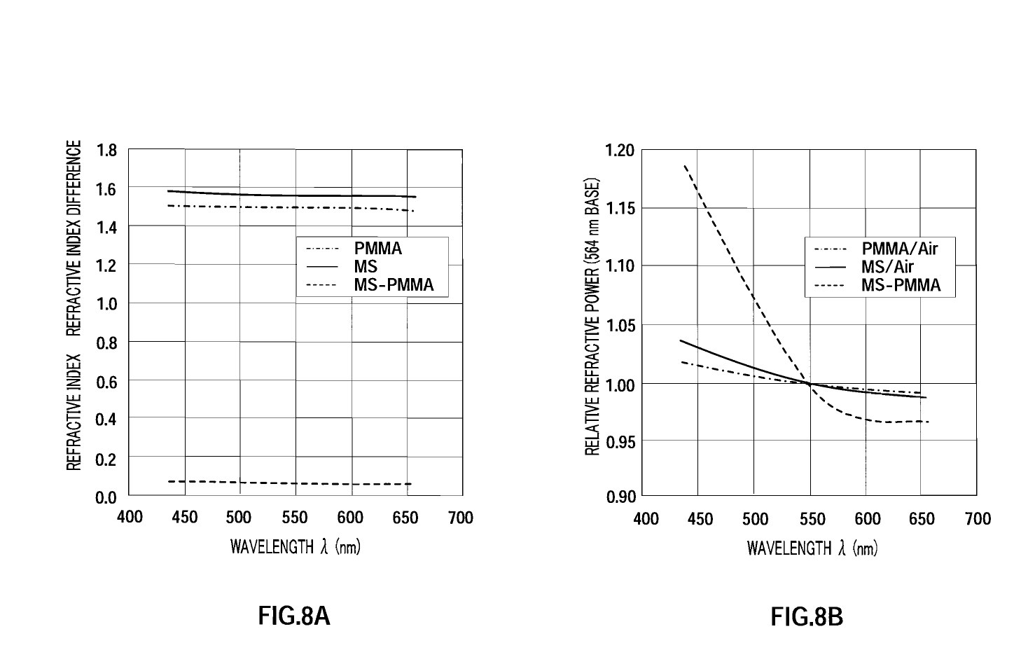

FIG. 8A is a graph showing the wavelength dependency of the refractive index of general PMMA (acrylic) and MS (a copolymer of acrylic and styrene) as a transparent resin material. The horizontal axis represents wavelength, and the vertical axis represents the refractive index. As shown in FIG. 8A, the refractive index is not fixed, but is wavelength-dependent (this kind of wavelength dependency phenomenon is called wavelength dispersion). With general optical materials, there is a tendency for the refractive index to be higher the shorter the wavelength. As absolute refractive power is small at the interface between transparent resin materials, a plurality of refractions are necessary. A method whereby light diffusers 340 are dispersed in the thickness direction in the base material of diffusion sheet 330 is effective for this purpose. Particles or fine fibers can be used as light diffusers 340.

When light is incident from a particular medium onto another medium with a different refractive index, refraction occurs at the interface in accordance with Snell's law, and the refractive power is proportional to the refractive index difference of the two media.

FIG. 8B is a graph showing the wavelength dependency of relative refractive power when above PMMA and MS are refracted at the interface with air (refractive index 1 irrespective of the wavelength), and at the interface of PMMA and MS. The horizontal axis represents wavelength, and the vertical axis represents relative refractive power. The vertical axis shows relative values with the refractive index difference normalized at a value for a 546 nm measurement wavelength.

As shown here, wavelength dispersion is significantly greater for refraction at the PMMA/MS interface than for refraction at the PMMA/air or MS/air interface. Implementation of diffusion with large wavelength dispersion can therefore be expected by using refraction at an interface of the two.

However, since the refractive index difference of the two is small, it is difficult to perform adequate diffusion with a 2-layer structure of PMMA and MS with one surface having projections and depressions as the interface, as in the case of an interface with air. Thus, opportunities for refraction are increased by using one material as a medium and dispersing light diffusers 340 of the other material therein in the thickness direction.

If fine fibers are used as light diffusers 340, illumination light can be obtained for which wavelength dispersion is large in the x direction and wavelength dispersion is small in the y direction. By using either particles or fine fibers, taking the light distribution characteristics of the plurality of single-color light sources into consideration, a liquid crystal display module can be implemented that effectively illuminates a liquid crystal panel that has wavelength dispersion and anisotropy in wavelength dependency such that the light distribution characteristic of emitted light from the liquid crystal panel differs on a wavelength-by-wavelength basis, and has a small color shift with respect to any observation angle, and that makes possible image display in which the light distribution characteristic balance has been adjusted.

If it is not necessary to impart wavelength dependency by means of diffusion sheet 330 to emitted light from the plurality of single-color light sources, it is not necessary for diffusion sheet 330 to have light diffusers 340. In this case, emitted light from the plurality of single-color light sources may be diffused using a commercially available diffusion sheet.

As described above, according to a configuration of the present invention, a liquid crystal display apparatus can be implemented that corrects wavelength dispersion and anisotropy in wavelength dependency such that the light distribution characteristic of emitted light from the liquid crystal panel differs on a wavelength-by-wavelength basis, and has high display quality with little color unevenness due to the observation angle, by means of a simple method without using a plurality of hologram sheets.

<Matrix-Type Liquid Crystal Display Apparatus>

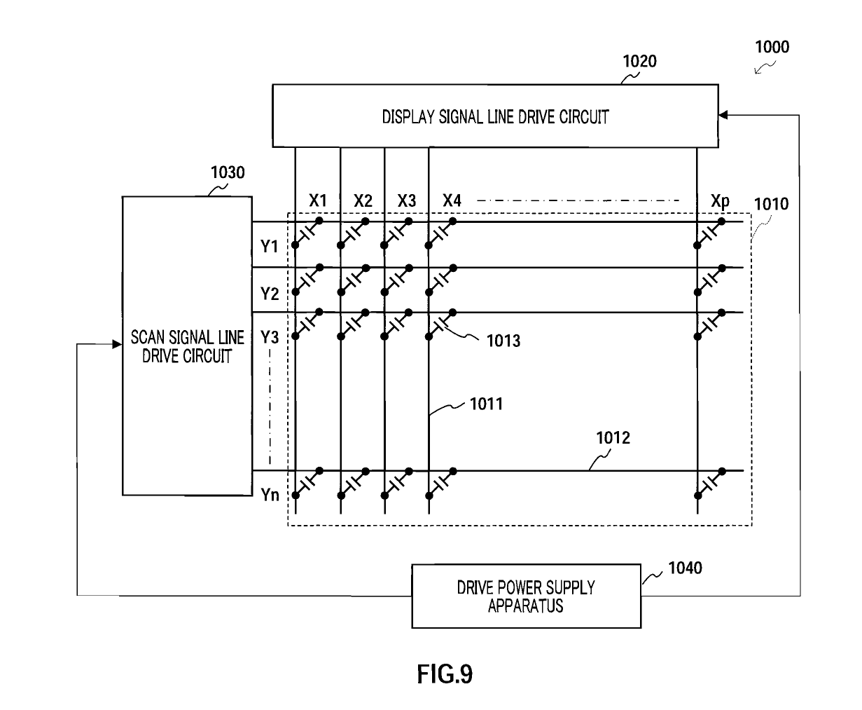

FIG. 9 shows an example of a matrix-type liquid crystal display apparatus. This matrix-type liquid crystal display apparatus 1000 is composed of matrix-type liquid crystal display module 1010, display signal line drive circuit 1020, and scan signal line drive circuit 1030. Display control circuitry of the present invention corresponds to display signal line drive circuit 1020 and scan signal line drive circuit 1030. Matrix-type liquid crystal display module 1010 is composed of a liquid crystal panel, a planar light source that illuminates the liquid crystal panel from its back surface, and a diffusion sheet that is positioned between the liquid crystal panel and the planar light source.

In the liquid crystal panel, p display signal lines 1011 and n scan signal lines 1012 are arranged in the form of a matrix, and a liquid crystal display element 1013 is formed between a signal electrode and scan electrode at each intersection point. Display signal line drive circuit 1020 outputs display signals (drive signals) via display signal lines 1011. Scan signal line drive circuit 1030 outputs scan signals via scan signal lines 1012. Liquid crystal display elements 1013 are driven by the potential difference between a display signal and a scan signal. Drive power supply apparatus 1040 supplies power to display signal line drive circuit 1020 and scan signal line drive circuit 1030.

Display signal line drive circuit 1020 and scan signal line drive circuit 1030 are formed from liquid crystal drive controller integrated circuits (ICs).

As the drive method of this matrix-type liquid crystal display apparatus 1000 by means of display signal line drive circuit 1020 and scan signal line drive circuit 1030, there is a time-division drive method whereby scan signals are output sequentially to scan signal lines 1012, and liquid crystal drive is performed by applying a selection voltage/non-selection voltage (scan signal) from display signal line 1011 according to selection/non-selection data for liquid crystal display element 1013 on scan signal line 1012 while that scan signal line 1012 is selected. With this time-division drive method, setting is performed so that the number obtained by dividing vertical synchronization signal cycle T by the period during which one scan signal line is selected is the same as number of scan signal lines n.

Since driving liquid crystal with a direct current causes deterioration of the liquid crystal itself, lowering display quality and significantly affecting operational life, liquid crystal requires alternating current drive, and in the above general matrix-type liquid crystal display apparatus 1000 time-division drive method, alternation is performed by driving with a polarity inversion (alternation) signal whose polarity is inverted each time natural number k (smaller than number of scan signal lines n) scan signal lines 1030 are selected.

The disclosure of Japanese Patent Application No. 2006-113147, filed on Apr. 17, 2006, including the specification, drawings and abstract, is incorporated herein by reference in its entirety.

### INDUSTRIAL APPLICABILITY

The present invention enables a video display to be implemented in which the occurrence of color unevenness due to the observation angle is reduced in the horizontal, vertical, and diagonal directions, and can contribute to improving the display performance of a video display apparatus such as a liquid crystal TV, liquid crystal monitor, or the like.

1. A liquid crystal display module comprising:
a liquid crystal panel having wavelength dependency whereby transmittance for incident illumination light differs according to both an incident angle and a wavelength of illumination light, and also having anisotropy whereby the wavelength dependency differs in a horizontal direction and a vertical direction; and
a plurality of single-color light sources whose emission wavelength light distribution characteristics differ and that illuminate the liquid crystal panel from a back surface,
wherein the plurality of single-color light sources emit illumination light having a light distribution characteristic that lessens the wavelength dependency and the anisotropy.

2. The liquid crystal display module according to claim 1, wherein emitted light colors of the plurality of single-color light sources are three primary colors red, green, and blue, and diffusion of blue is relatively large.

3. The liquid crystal display module according to claim 1, wherein the plurality of single-color light sources are arranged so as to have directivity in a horizontal direction of the liquid crystal panel.

4. The liquid crystal display module according to claim 1, wherein the plurality of single-color light sources are arranged so as to have a light distribution characteristic with large diffusion in a vertical direction of the liquid crystal panel.

5. The liquid crystal display module according to claim 1, further comprising a diffusion sheet between the plurality of single-color light sources and the liquid crystal panel,
wherein light distribution characteristics of the plurality of single-color light sources and a light distribution characteristic of the diffusion sheet are set so as to lessen the wavelength dependency and the anisotropy.

6. The liquid crystal display module according to claim 1, further comprising a diffusion sheet between the plurality of single-color light sources and the liquid crystal panel,
wherein the diffusion sheet has, within a transparent base material, light diffusers having a refractive index different from a refractive index of the base material, dispersed in a thickness direction of the transparent base material, causes light emitted from the plurality of single-color light sources to be refracted a plurality of times, imparts wavelength dependency that is a reverse of the wavelength dependency to light emitted from the plurality of single-color light sources, and emits that light.

7. An illumination apparatus that illuminates from its back surface a liquid crystal panel having wavelength dependency whereby transmittance for incident illumination light differs according to both an incident angle and wavelength of the illumination light, and also having anisotropy whereby the wavelength dependency differs in a horizontal direction and a vertical direction, the illumination apparatus comprising:
a plurality of single-color light sources whose emission wavelength light distribution characteristics differ; and
a base on which the plurality of single-color light sources are arranged,
wherein the plurality of single-color light sources emit illumination light having a light distribution characteristic that lessens the wavelength dependency and the anisotropy.

8. The illumination apparatus according to claim 7, wherein emitted light colors of the plurality of single-color light sources are three primary colors red, green, and blue, and diffusion of blue is relatively large.

9. The illumination apparatus according to claim 7, wherein the plurality of single-color light sources are arranged so as to have directivity in a horizontal direction of the liquid crystal panel.

10. The illumination apparatus according to claim 7, wherein the plurality of single-color light sources are arranged so as to have a light distribution characteristic with large diffusion in a vertical direction of the liquid crystal panel.

11. The illumination apparatus according to claim 7, further comprising a diffusion sheet between the plurality of single-color light sources and the liquid crystal panel,
wherein light distribution characteristics of the plurality of single-color light sources and a light distribution characteristic of the diffusion sheet are set so as to lessen the wavelength dependency and the anisotropy.

12. The illumination apparatus according to claim 7, further comprising a diffusion sheet between the plurality of single-color light sources and the liquid crystal panel,
wherein the diffusion sheet has, within a transparent base material, light diffusers having a refractive index different from a refractive index of the base material, dispersed in a thickness direction of the transparent base material, causes light emitted from the plurality of single-color light sources to be refracted a plurality of times, imparts wavelength dependency that is a reverse of the wavelength dependency to light emitted from the plurality of single-color light sources, and emits that light.

13. A liquid crystal display apparatus of the present invention comprising:
a liquid crystal panel having wavelength dependency whereby transmittance for incident illumination light differs according to both an incident angle and wavelength of the illumination light, and also having anisotropy whereby the wavelength dependency differs in a horizontal direction and a vertical direction;
an illumination section that has a plurality of single-color light sources whose emission wavelength light distribution characteristics differ and that illuminate the liquid crystal panel from aback surface, and illuminates the liquid crystal panel from the back surface; and
a display control circuit that drives the liquid crystal panel and displays an image,
wherein the plurality of single-color light sources emit illumination light having a light distribution characteristic that lessens the wavelength dependency and the anisotropy.

14. The liquid crystal display apparatus according to claim 13, wherein emitted light colors of the plurality of single-color light sources are three primary colors red, green, and blue, and diffusion of blue is relatively large.

15. The liquid crystal display apparatus according to claim 13, wherein the plurality of single-color light sources are arranged so as to have directivity in a horizontal direction of the liquid crystal panel.

16. The liquid crystal display apparatus according to claim 13, wherein the plurality of single-color light sources are arranged so as to have a light distribution characteristic with large diffusion in a vertical direction of the liquid crystal panel.

17. The liquid crystal display apparatus according to claim 13, further comprising a diffusion sheet between the plurality of single-color light sources and the liquid crystal panel,
wherein light distribution characteristics of the plurality of single-color light sources and a light distribution characteristic of the diffusion sheet are set so as to lessen the wavelength dependency and the anisotropy.

18. The liquid crystal display apparatus according to claim 13, further comprising a diffusion sheet between the plurality of single-color light sources and the liquid crystal panel,
wherein the diffusion sheet has, within a transparent base material, light diffusers having a refractive index different from a refractive index of the base material, dispersed in a thickness direction of the transparent base material, causes light emitted from the plurality of single-color light sources to be refracted a plurality of times, imparts wavelength dependency that is a reverse of the wavelength dependency to light emitted from the plurality of single-color light sources, and emits that light.
